(19) United States
(12) Patent Application Publication
(10) Pub. No.: US 2018/0176089 A1
(43) Pub. Date: Jun. 21, 2018

(54) INTEGRATION SCENARIO DOMAIN-SPECIFIC AND LEVELED RESOURCE ELASTICITY AND MANAGEMENT

(71) Applicant: SAP SE, Walldorf (DE)

(72) Inventors: Daniel Ritter, Heidelberg (DE); Manuel Holzleitner, Karlsruhe (DE); Anna Sophie Rodewald, Karlsruhe (DE)

(21) Appl. No.: 15/381,933

(22) Filed: Dec. 16, 2016

(51) Int. Cl. H04L 12/24; H04L 12/26

(52) U.S. Cl. CPC H04L 41/0896; H04L 43/0876

(57) ABSTRACT

System-level resource capacities and application-level resource capacities associated with an integration system in a distributed computing environment are determined, where the integration system includes an integration process. A workload associated with the integration system is identified based on the determined system-level capacities and application-level capacities. At least one constraint associated with the integration system is identified. A countermeasure is determined for resource elasticity and management based on the identified workload and constraint.

### BACKGROUND

In distributed computing systems, for example, cloud or mobile computing systems, efficient resource usage is reached by analyzing load patterns and situations (for example, static, periodic, once-in-a-time, unpredictable or continuously changing workload). A common countermeasure is elasticity, which is the flexibility of entities (for example, system or component) to autonomously adapt its capacity to workload over time. Thereby the elasticity properties are bound to trade-offs “stateful versus stateless” components (that is, stateless is better suitable for elasticity), latency versus throughput, throughput versus stability and further for stateful “strict versus eventual consistent”. Since elasticity is crucial for environmental aspects of distributed computing systems (for example, energy efficiency or resource usage), much academic and industrial work has been done on an architectural system level. Treating elasticity on a system level is done based on system and usage statistics (for example, memory or CPU consumption, or a number of connections). When a certain threshold is reached (for example, resource limits), another processing node is started and the load is dispatched on a system/node level. Common techniques for elasticity on a system level are based on hybrid reactive and predictive schemes.

When treating elasticity and resource consumption on a system level, limits and capacities of resources on lower levels (for example, software module, sequence of modules, or external resource access) are not taken into account. This can lead to situations, in which the overall system threshold is not reached (that is, no countermeasure applied), however, the limits of the lower level resources (for example, content or external services) are at their peak (for example, a number of connections to external services, throughput limit of software module). A formal elasticity model for these artifacts and their limits is currently not available. Therefore, the limits of the lower level resources cannot be managed by the existing, system-level approaches/concepts and framework implementations. For instance, hypervisors or virtual machine monitors would not be able to optimize. An overall, combined, and optimal treatment of system and domain-level resources and elasticity has not been considered by existing approaches.

### SUMMARY

The present disclosure describes methods and systems, including computer-implemented methods, computer program products, and computer systems for integration scenario domain-specific and leveled resource elasticity and management.

In an implementation, system-level resource capacities and application-level resource capacities associated with an integration system in a distributed computing environment are determined, where the integration system includes an integration process. A workload associated with the integration system is identified based on the determined system-level capacities and application-level capacities. At least one constraint associated with the integration system is identified. A countermeasure is determined for resource elasticity and management based on the identified workload and constraint.

The above-described implementation is implementable using a computer-implemented method; a non-transitory, computer-readable medium storing computer-readable instructions to perform the computer-implemented method; and a computer-implemented system comprising a computer memory interoperably coupled with a hardware processor configured to perform the computer-implemented method/the instructions stored on the non-transitory, computer-readable medium.

The subject matter described in this specification can be implemented in particular implementations so as to realize one or more of the following advantages. First, the describe approach enables optimal resource elasticity by taking account of resource capacities at both system levels and lower levels such as application-specific resource limits. Second, the described approach can detect and predict a load situation in the system, and determine countermeasures based on the predicted load situation and constraints in the system. Third, the describe approach enables an optimal action plan for resource management by taking account of effectiveness of previous action plans. The described approach assesses its quality by monitoring decisions and action plans to optimally adapt to new situations over time. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a high-level overview of an integration system, according to an implementation.

FIG. 2 is an example of automatic resource management in a virtualized computing environment, according to an implementation.

FIG. 3 is a conceptual diagram that connects different resource limits and thresholds, according to an implementation.

FIG. 4A shows an example of constant overload, according to an implementation.

FIG. 4B shows an example of approaching overload, according to an implementation.

FIGS. 4C and 4D show two examples of increasing overload, according to an implementation.

FIGS. 4E and 4F show two examples of steadying overload, according to an implementation.

FIG. 5A shows an example of constant free capacity, according to an implementation.

FIG. 5B shows an example of approaching equal capacity, according to an implementation.

FIGS. 5C-5H show examples of approaching free capacity and increasing free capacity, according to an implementation.

FIG. 6A shows a first special case associated with macro-level classifiers, according to an implementation.

FIG. 6B shows a second special case associated with macro-level classifiers, according to an implementation.

FIG. 7 shows micro and macro classifiers, according to an implementation.

FIG. 8A shows a scalable sender adapter, according to an implementation.

FIG. 8B shows a scalable receiver adapter, according to an implementation.

FIG. 9 shows a scalable message processor, according to an implementation.

FIG. 10 shows a scalable sub-process, according to an implementation.

FIG. 11 shows a scalable integration process 1100, according to an implementation.

FIG. 12 shows a decision tree to illustrate applicable operations, according to an implementation.

FIG. 13 shows a general state machine with memory that illustrates behavioral aspects of integration scenario domain-specific and leveled resource elasticity and management, according to an implementation.

FIG. 14 is a diagram illustrating integration scenario domain-specific and leveled resource elasticity and management, according to an implementation.

FIG. 15 demonstrates a system that executes design aspects of integration scenario domain-specific and leveled resource elasticity and management, according to an implementation.

FIG. 16 is a block diagram illustrating an exemplary computer system used to provide computational functionalities associated with described algorithms, methods, functions, processes, flows, and procedures as described in the instant disclosure, according to an implementation.

Like reference numbers and designations in the various drawings indicate like elements.

### DETAILED DESCRIPTION

The following detailed description describes integration scenario domain-specific and leveled resource elasticity and management and is presented to enable any person skilled in the art to make and use the disclosed subject matter in the context of one or more particular implementations. Various modifications to the disclosed implementations will be readily apparent to those of ordinary skill in the art, and described principles may be applied to other implementations and applications without departing from the scope of the disclosure. Thus, the present disclosure is not intended to be limited to the described or illustrated implementations, but is to be accorded the widest scope consistent with the principles and features disclosed herein.

In distributed computing systems, for example, cloud or mobile computing systems, efficient resource usage is reached by analyzing load patterns and situations (for example, static, periodic, once-in-a-time, unpredictable, or continuously changing workload). A common countermeasure is elasticity, which is the flexibility of entities (for example, system or component) to autonomously adapt its capacity to workload over time. Thereby, the elasticity properties are bound to trade-offs; “stateful versus stateless” components (that is, stateless is better suitable for elasticity), latency versus throughput, throughput versus stability, and further for stateful “strict versus eventual consistent”. Since elasticity is crucial for environmental aspects of distributed computing systems (for example, energy efficiency or resource usage), much academic and industrial work has been done on an architectural system level. Treating elasticity on a system level is done based on system and usage statistics (for example, memory or CPU consumption, or a number of connections). When a certain threshold is reached (for example, resource limits), another processing node is started and the load is dispatched on a system/node level. Common techniques for elasticity on a system level are based on hybrid reactive and predictive schemes.

When treating elasticity and resource consumption on a system level, limits and capacities of resources on lower levels (for example, software module, sequence of modules, or external resource access) are not taken into account. This can lead to situations, in which the overall system threshold is not reached (that is, no countermeasure applied), however, the limits of the lower level resources (for example, content or external services) are at their peak (for example, a number of connections to external services, throughput limit of software module). A formal elasticity model for these artifacts and their limits is currently not available. Therefore, the limits of the lower level resources cannot be managed by the existing, system-level approaches/concepts and framework implementations. For instance, hypervisors or virtual machine (VM) monitors would not be able to optimize. An overall, combined, and optimal treatment of system and domain-level resources and elasticity has not been considered by existing approaches.

At a high-level, the described approach focuses on the integration domain, for example, integration process as sequence of adapters, operator modules, and service dependencies/resources (for example, CPU, memory, disk, database, queuing). The described approach also addresses the following levels (from high level to low level): system, integration process, endpoint/adapter, single operator module, and single service dependency/resource.

Most of the existing approaches simply try to scale as elasticity strategy, some even “scale-back” to free resources. The described approach focuses on the scale out and back based on a hybrid rule-based and predictive machine learning scheme. The described approach uses a meta-model for multi-level resource management and elasticity. The described approach employs the following machine learning components:
a model of an elastic artifacts controller for multiple elasticity levels (reactive and predictive) to produce elasticity plans;
a rule-based plan executor that defines the elasticity strategy and executes the plans in this context, and
a learning controller that evaluates the quality of elasticity plans based on the same statistics and its result (corrective).
   The described approach defines possible and allowed strategies and countermeasures for scale, as well as patterns for elasticity.

Efficient usage of computing resources on a system level has been well-addressed, by existing approaches, on a VM and system level for domains like hardware virtualization, database systems, and cloud computing by non-functional countermeasures like scalability (that is, vertical or horizontal scalability) and partially even the re-distribution of resources, when the load decreases below the system's capacity (that is, elasticity). The application integration domain leverages these results on the grain-granular system level for processing the increasing message workload generated by a growing number of applications (for example, business, cloud, or mobile applications), and Internet of Things (IoT) devices. This grain granular resource management by existing approaches works well for cases in which no additional cost constraints (for example, cost of VM or hardware) play a role or one integration scenario fully utilizes the resources. Typically, resources within integration scenarios can be a number of connections supported by integration adapters, capacity of the integration adapters, and capacity of the integration operations within the integration process.

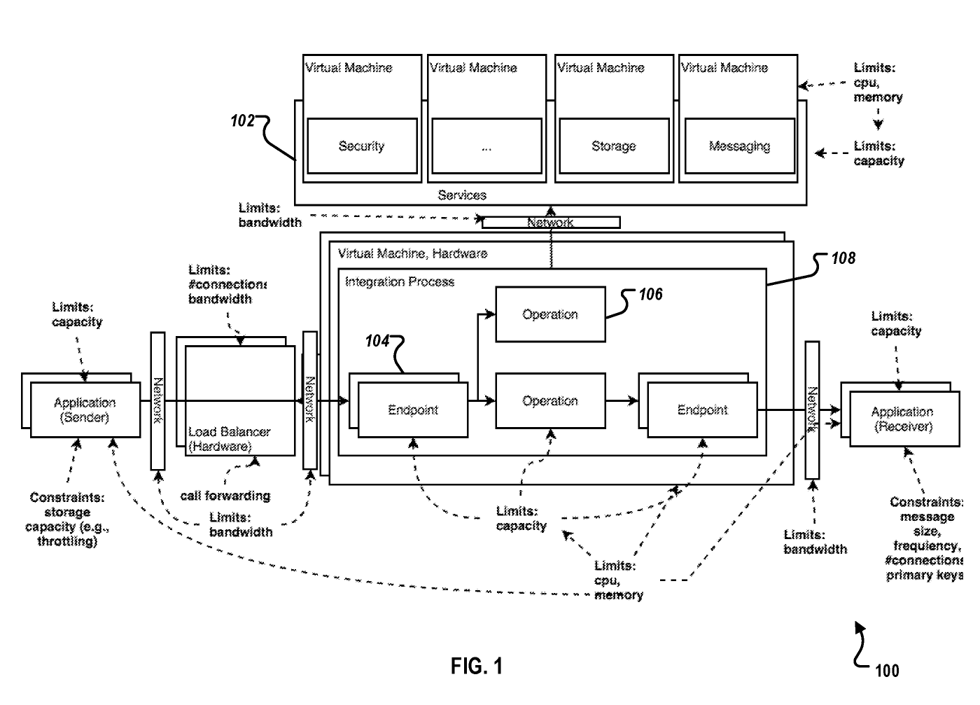

FIG. 1 is a high-level overview of an integration system 100, according to an implementation. The integration system is associated with capacities, constraints, and limitations on different levels, for example, integration process content, required services 102, endpoints 104, and auxiliary infrastructure. Note that distinct components each have their limits and derived limits from the environment (that is, dependency hierarchies). For instance, an operation 106 within an integration process 108 has certain throughput limits, which are limited by CPU and memory from the environment, that is, the platform on which it runs. Hence, to overcome these limits, parallel processing could be a countermeasure, however, only within the limits of the environment.

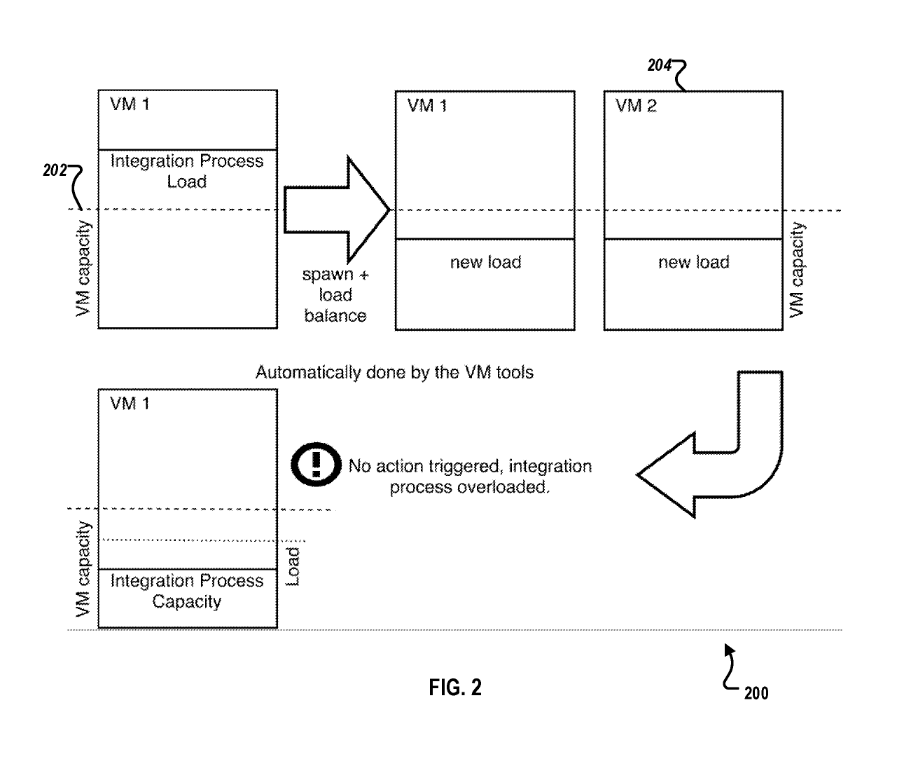

FIG. 2 is an example of automatic resource management 200 in a virtualized computing environment, according to an implementation. The upper part of FIG. 2 shows that as soon as a resource threshold is reached (for example, memory or CPU consumption reaches the VM capacity 202), another VM instance 204 is spawned and hardware load-balancing equally distributes the load to the two computing nodes. However, in case no more connections of the inbound adapter (for example, HTTP or TCP) can be accepted or the integration operations within the integration process reach their limits, the integration process is over limit. Consequently, as shown in the lower part of FIG. 2, the automatic scaling of the higher-level resource layer does not kick in because of lack of knowledge of the lower-level, “application-specific” limits. In other words, VM instances may not be spawned when the integration process is overloaded, but the VM capacity is not reached.

The described approach, compared to existing approaches, enables a more fine-granular resource management approach on the integration process or even adapter and operation levels that targets several integration system limits (for example, bandwidth, capacity, and a number of connections). The described approach allows the integration system to react adequately on potential overload situations on a more fine-granular, domain-specific level (for example, content-level). The described approach includes:
load profile and elasticity case analysis and categorization;
countermeasures and elasticity constraints expressed as patterns (analysis of patterns within the scenarios and their elasticity constraints and capabilities, for example, which pattern can be elastic);
elasticity model for countermeasures and scale variants; and
evaluation showing the benefits of the solutions or countermeasures.

Resources and Capacities

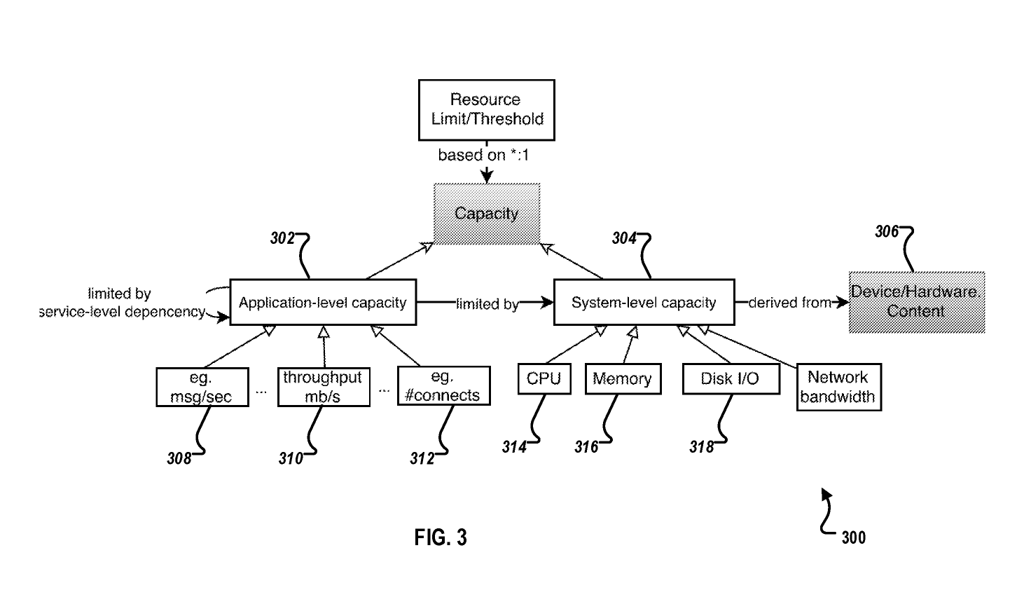

FIG. 3 is a conceptual diagram 300 that connects different resource limits and thresholds, according to an implementation. As discussed above, resource limits and thresholds denote “natural” capacity boundaries on system and application levels. The system-level capacities 304 are directly derived from the underlying device/hardware or indirectly from VM settings or content 306. The application-level capacities 302 are limited by (a) the system-level capacities 304 and (b) application-level capacities from auxiliary services like storage, security, or messaging. Furthermore, more fine-granular capacity levels on the integration content parts are differentiated, for example, message throughput 310 for operations and adapters, and a number of connections 312 for adapters. Various resources on the system-level and application-level can include:
content
   integration process
   integration adapter
   integration operations (that is, message processors; integration operations can also be called enterprise integration patterns (EIPs))
   services (for example, number of calls to database)
capacities and thresholds
   throughput 310
   resources: disk 318, memory 316, CPU 314
   message sizes
   a number of messages 308
   a number of connections 312 (for example, a number of connections of clients to a message broker, a number of consumers)
thresholds
   complex metrics

Definition of Classifiers

A classifier categorizes resource and load situations based on temporal variations of (discrete) capacity utilization in relation to defined thresholds. For different environments, the described approach defines a capacity derivation methodology. For example, integration throughput of an operation or adapter can be experimentally determined and a benchmark can be used so that the classifier can be learned. An algorithm for determining the message throughput capacity classification can include:
testing integration process baseline;
testing message processor in integration process for different message sizes and condition complexities;
capturing measured throughput and categorize relative to each other as capacities with high, medium and low throughput (for example, build these classes equi-distant by taking the highest and lowest values for simple pattern benchmarks or with more sophisticated distribution); and
returning capacity categories (for example, as measured for content-based router, message translator and splitter cases).
   CPU, memory, and other system thresholds can be measured using respective operating system (OS) tools.

Other resource consumption can occur for external services (for example, database (DB), message queuing (MQ), and landscape directories). The resource consumption information of external services can be collected in a minimally intrusive way on the runtime system with adapted metrics for each service. As discussed below, the information about external services has to be taken into account before applying a countermeasure.

Load Situation Classifiers

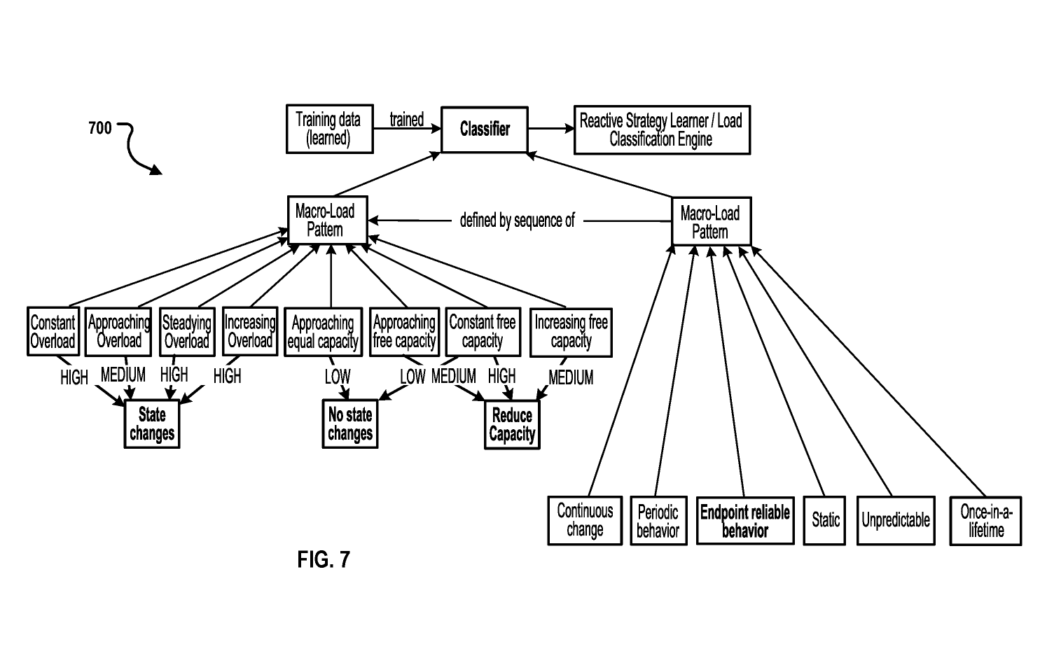

The described approach derives load situation classifiers from common load situations as patterns. The load situations can include (as shown in FIG. 7):
Changes required:
   periodic workload: re-occurring time interval
      special case: continuously changing, grows and shrinks constantly
   unpredictable: random and unforeseeable utilization
No changes required (or only once or twice):
   static workload: equal utilization, change only if load is higher (one change)
   once-in-a-lifetime: strong peak occurring only once

Definition of Load Patterns

In the described approach, load patterns denote a set of metrics capturing the usage statistics that match with systems' resources, limits, and thresholds. Hereby, usage statistics use system resources like message throughput per time, service usage statistics, etc. As discussed above, capacity is the maximal processable load and limit as specific maximum load lower than the capacity (that is, which would trigger a change).

Scale Micro-Load Classifier: Cases Where Changes Make Sense
Known resource baseline capacity, execution statistics and usage
Action cases/countermeasures (as will be discussed later) enable active load situations
   Not in all situations changes make sense. For instance, for monotonous, stable load situations, the system does not need to change, if the situation itself is not critical. Thereby, active load situations denote cases, in which the system has to react/do something (that is, apply a countermeasure).

State Changes

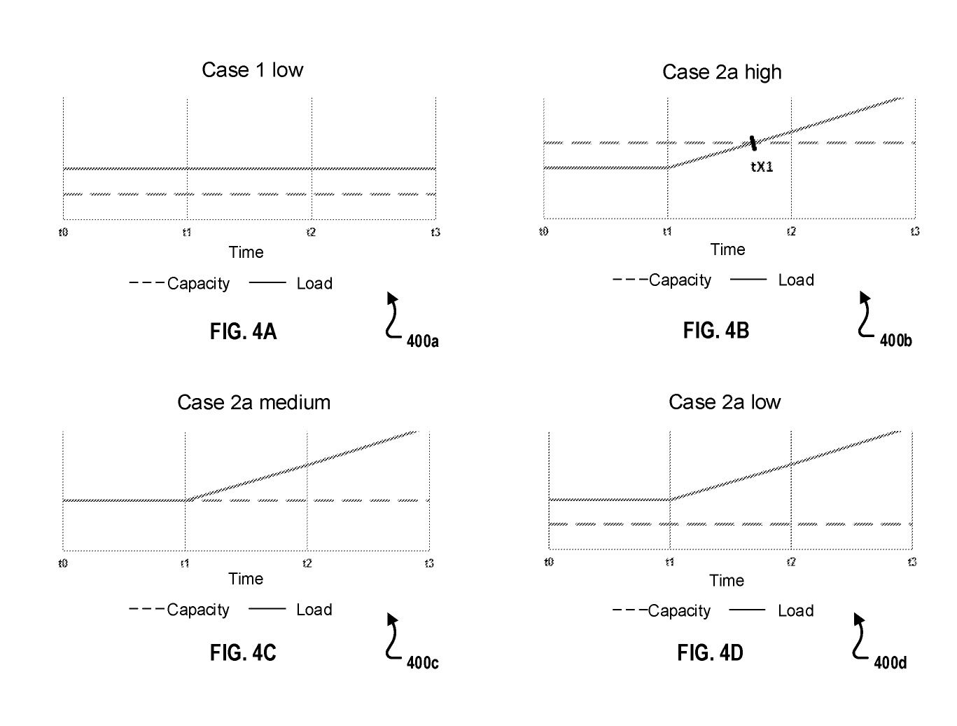

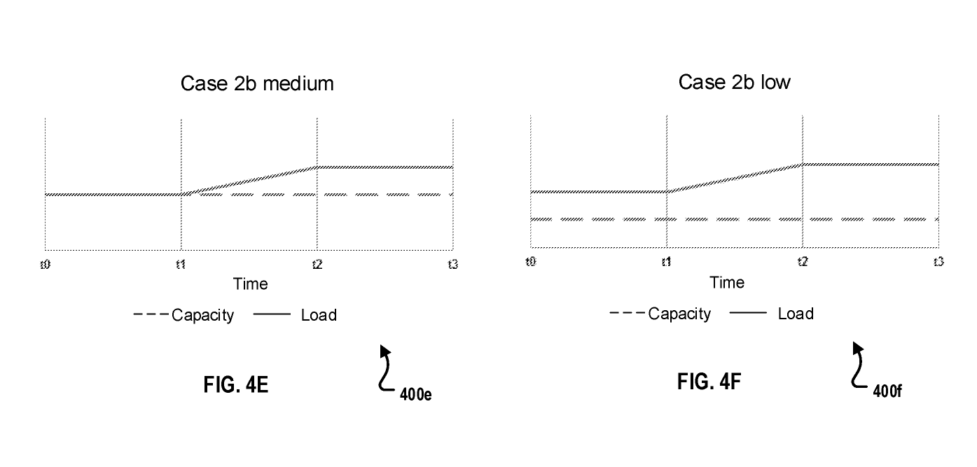

The described approach limits the responses of the system to state changes. State changes lead to actions that shall be triggered. Therefore, the described approach differentiates between urgencies for actions. The following urgencies for actions can be used: high (stability or limits in danger, and immediate action for no time to lose), medium (predicted thresholds show a need for actions, and do something without hurry), low (actions can be done later). The micro-load patterns that involve state changes are (as shown in FIG. 7):
constant overload (urgency=high): capacity lower than current load. FIG. 4A shows an example 400a of constant overload, according to an implementation;
approaching overload (urgency=medium) and increasing overload (urgency=high): lower or equal load compared to current capacity increases (crossing) above capacity limits. FIG. 4B shows an example 400b of approaching overload, according to an implementation. FIGS. 4C and 4D show two examples 400c and 400d of increasing overload, according to an implementation; and
steadying overload (urgency=high): equal or lower load compared to current capacity increases (crossing) above capacity limits. FIGS. 4E and 4F show two examples 400e and 400f of steadying overload, according to an implementation.

No State Changes (Urgency Always Low or None)

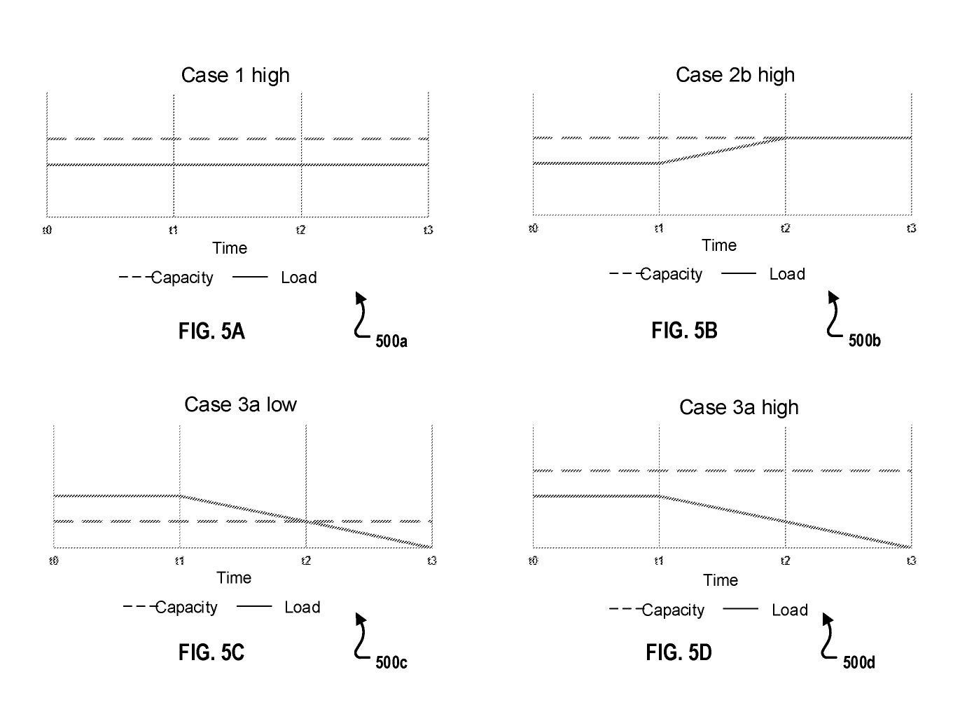

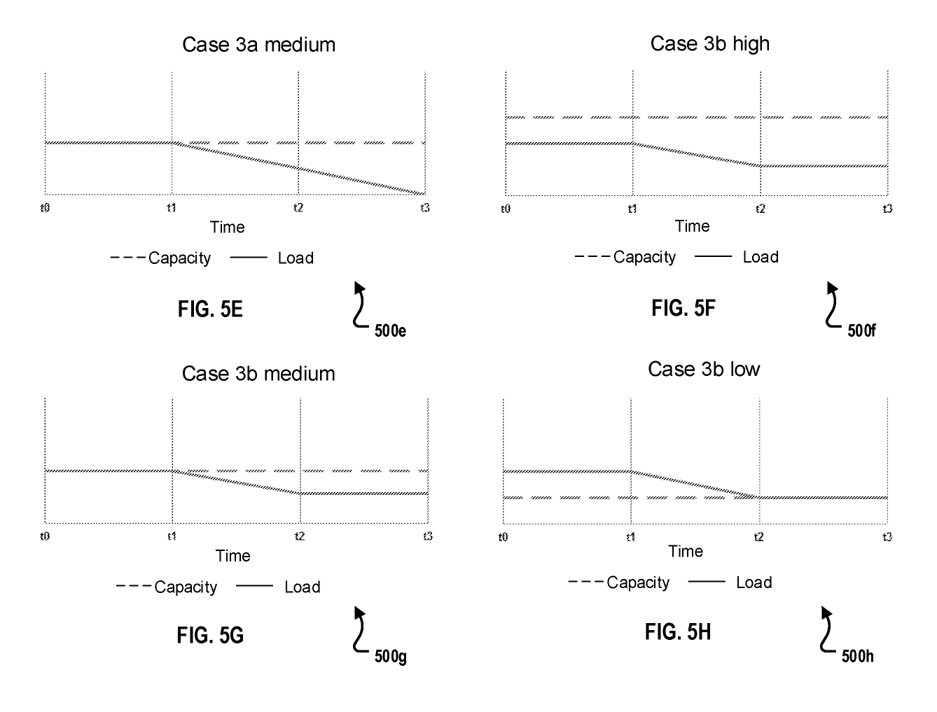

The described approach also introduces “none” as urgency, which means that the situation is within normal parameters and no action required. The micro-load patterns that involve no state changes (that is, urgency always low or none) are (as shown in FIG. 7):
constant free capacity: current capacity is higher than current load. FIG. 5A shows an example 500a of constant free capacity, according to an implementation
approaching equal capacity: lower load compared to current capacity increases, but remains lower or equal to capacity limits. FIG. 5B shows an example 500b of approaching equal capacity, according to an implementation
approaching free capacity (urgency=low) and increasing free capacity (urgency=low): lower load compared to current baseline capacity decreases even further (no action possible due to baseline capacity cannot be further reduced). FIGS. 5C-5H show examples 500c-500h of approaching free capacity and increasing free capacity, according to an implementation

State Changes in Cases when Capacity could be Reduced

So far, the describe approach only considers scale out cases. However, when the resources are not used any more, a reduction of the resources makes sense (for example, for cost reasons). The micro-load patterns, in which state changes and capacity can be reduce can include:
constant free capacity (urgency=high);
approaching free capacity (urgency=medium); and
increasing free capacity (urgency=medium).

Macro-Level Classifier (Combined Micro Classifier)

The previously discussed classifiers consider a micro-level time window on the current load situation (that is, local view). However, there are effects that one might want to avoid, which are not trackable on a local view only. Therefore, macro-level classifiers that capture these situations are defined (as shown in FIG. 7):
periodic behavior (combination of micro-level classifiers)
   special cases: continuous change (with scale)
reliable behavior of sender endpoint (track reaction to advices)

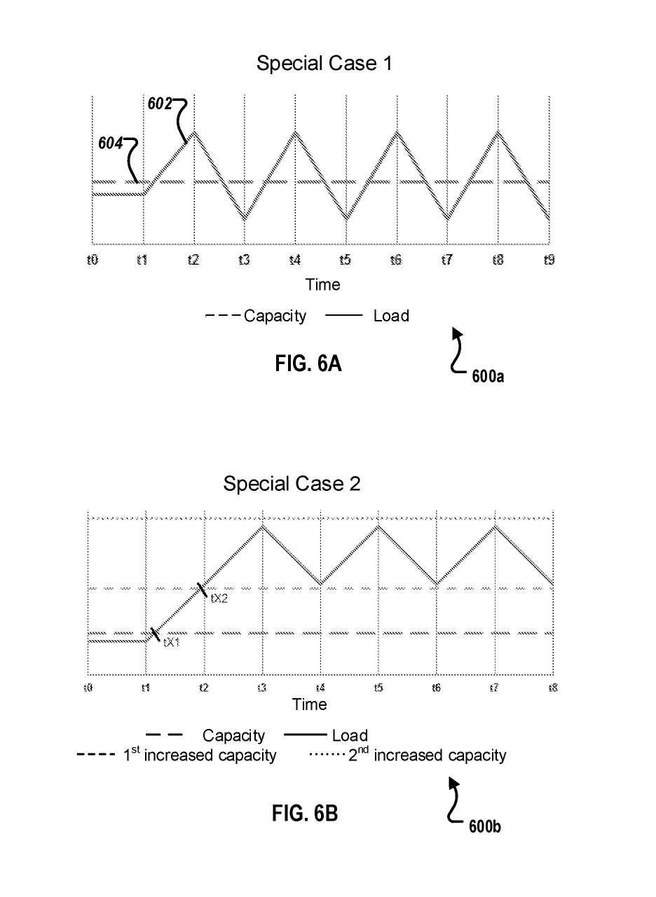

FIG. 6A shows a first special case 600a associated with macro-level classifiers, according to an implementation. The first special case shows a stable oscillating load pattern 602 along the resource limit or capacity 604 that would lead to periodically flapping optimizations, when only identified using a micro classifier. For instance, between time t1 and t2, the micro-classifier would report on “approaching overload”, which would lead to an optimization like scale. However, directly afterwards, the load would drop and the micro-classifier would report “approaching free capacity”. That would lead to a scale down. Depending on the load pattern's frequency, a re-optimization would be performed, before the actual optimization could kick in.

Hence a macro-classifier is learned and used to detect this alternating load pattern and take a decision coordinating the micro-classifier evaluation. For instance, in the first special case:
The scale down could be prevented until the situation does not change towards “increasing free capacity”.
But only if, cost considerations do not play a role, then the scale out could be prevented and the overload could be accepted, if the stability is not at risk (that is, the resources limits are not reached).

FIG. 6B shows a second special case 600b associated with macro-level classifiers, according to an implementation. In this case, the scale out was not sufficient. Thereafter an alternating behavior indicates rise and fall towards free capacity. The micro-classifier rule might decide to wait until free capacity is reached. However, during the whole time, the system is in an overload situation. A macro classifier could detect and react accordingly, by another scale out.

A third special case is once-in-a-lifetime overload. While a micro-classifier, would react immediately, a macro classifier could deal with it by not rushing one optimization after the other to try to catch the peak, just to reduce it afterwards to the normal level. However, application specific peak loads, for example, at the beginning of the month, can be handled by the macro classifier as well.

Summary: Micro-Level Scale Up and Down

The described approach defines resources and capacities, limits/thresholds, and classifiers for all potential workload situations (for example, overload implies urgent situations) as base class of all resource constraints (for example, message throughput, number of connections, and size of memory):
down-scale cases:
   constant free capacity (such as case 1 high shown in FIG. 5A)
   approaching free capacity (such as cases 3a low, 3a medium, and 3a high shown in FIGS. 5C, 5E, and 5D, respectively)
   increasing free capacity (such as cases 3b high and 3b medium shown in FIGS. 5F and 5G, respectively)
up-scale cases:
   constant overload (such as case 1 low shown in FIG. 4A)
   approaching overload (such as cases 2a low, 2a medium, and 2a high shown in FIGS. 4D, 4C, and 4B, respectively)
   steadying overload (such as 2b low and 2b medium shown in FIGS. 4F and 4E, respectively)

FIG. 7 shows micro and macro classifiers, according to an implementation. The micro and macro load patterns discussed above are summarized in FIG. 7. The macro classifier is defined as a sequence of micro classifiers. The described approach targets (a) the identification of micro classifier and (b) the derivation of macro classifier. Finally, the macro classifier has to learn not to exceed the system's resources and decide to avoid optimizations accordingly.

Countermeasure/Patterns

The described approach identifies the following countermeasure categories:
data-centric (for integration)
scale
flow control
   The described approach includes a list of countermeasures, which are defined as patterns, as well as the description of these patterns with new pattern format extensions for its effect, the affected resource, whether it makes sense (load pattern), the resulting consequences, and configuration aspects. Based on this novel categorization, the described approach derives countermeasure groups that serve as the foundation for action plans. In addition, cross group action plans are defined.

Date-Centric

The data-centric countermeasure patterns for message-based integration target any kinds of data and data flow aspects of integration. Tables 1.1 and 1.2 describe data-centric countermeasures. Note that Table 1.2 is a continuation of Table 1.1, where Tables 1.1 and 1.2 together form a complete table describing data-centric countermeasures. When Tables 1.1 and 1.2 form into a complete table, the column of consequences in Table 1.2 is adjacent to the column of on which resources in Table 1.1. In other words, each data-centric countermeasure is described by columns in order of name, known implementations, covered by current EIPs, effect, on which resources, consequences, configuration, and expected time to effect.

The data-centric countermeasures can perform:
micro-batching (batch size): collect message depending on time, number or other criteria and send it as collection of messages;
streaming (if streaming is supportable): streaming is a technique that allows to process untractable amounts of data by only materializing parts at a time. That reduces the CPU and memory consumption of the system, however, not all operations are streaming enabled;
stateful vs stateless (depends on whether persistence is required or not);
condition re-ordering: in some cases, the placement of the conditions might not be done in the optimal order. For instance, an early filter operation—if allowed—would reduce the amount of data for all subsequent operations; and
push-downs (for example, selections, projections): in some cases, processing is moved to the caller to gain an optimal end-to-end processing.
sample
message size limiting
split messages, data partitioning

TABLE 1.1
Data-centric countermeasures

| | Known | Covered by | | On Which |
|---|---|---|---|---|
| Name | Implementations | current EIPs | Effect | Resources |
| Micro- | Table-centric | No (similar to | Reduces number of | Number of |
| Batcher | Processing | special type of | messages and | messages, |
| | components, | aggregator) | frequency, increases | message |
| | APACHE FLINK, | | message size | frequency, |
| | SPARK | | | message size |
| Streaming | APACHE | No | Flat line | Data sizes, |
| steps, | CAMEL, FLINK, | | connections, | number of |
| adapters | STORM, SPARK | | synchronous, data | connections, |
| | | | size regulation (If all | memory |
| | | | integration process | |
| | | | steps and adapters | |
| | | | support streaming → | |
| | | | static analysis.) | |
| Early | None | No | By executing the | Number of |
| Selection | | | selection as early as | messages, CPU |
| | | | possible in the | |
| | | | integration process | |
| | | | the following | |
| | | | unnecessary steps | |
| | | | will not be executed | |
| Condition | None | No | Optimizing for | Number of |
| re-ordering | | | early-outs on | messages |
| | | | conditions by | |
| | | | reordering | |
| | | | conditions to | |
| | | | increase condition | |
| | | | evaluation | |
| | | | performance | |
| Early | None | No | Message size | Messages |
| Projection | | | reduction | |
| Sampler | APACHE | No | Dropping messages | Number of |
| | CAMEL | | as soon as overload | messages |
| | | | is reached. | |
| Message | SAP HCI | No | Rejects messages → | message size |
| size-based | | | reduction in | |
| rejector | | | bandwidth/ | |
| | | | throughput, memory | |
| | | | consumption (non- | |
| | | | streaming case) | |
| Splitter | APACHE | Yes | increasing number | Number of |
| | CAMEL, SAP | | of messages, smaller | messages, |
| | HCI | | messages | message size |
| Data | None | Not | Balances messages | messages |
| Partitioner | | | for more efficient | |
| | | | processing | |

TABLE 1.2
Data-centric countermeasures (Continued)

| | | | Expected time |
|---|---|---|---|
| Name | Consequences | Configuration | to effect |
| Micro- | integration system (IS) and | Batch size, batch | immediate |
| Batcher | receiver get messages as chunks | collection time, batch | |
| | → more optimal processing | correlation properties, | |
| | → ability to handle larger message | dynamic batch re- | |
| | sizes | adjustment, header and | |
| | → table-centric pattern support | attachment treatment | |
| | Increases latency for messages. | properties; isBatching | |
| | | property for integration | |
| | | process steps | |
| Streaming | Messages of bigger data sizes can | isStreaming property for | immediate |
| steps, | be processed, if and only if, the | integration process steps | |
| adapters | messages do not need to be in the | | |
| | IS completely | | |
| | → streaming pattern support | | |
| | → ability to handle messages | | |
| | larger than system capacities and | | |
| | resources | | |
| Early | Not applicable in all | Selectors, queries | Application |
| Selection | scenarios/cases. Requires | | bound |
| | additional data flow analysis for | | |
| | guided optimization. | | |
| Condition | Requires profiling during | | Load bound |
| re-ordering | evaluation and may requires re- | | |
| | optimization when load changes | | |
| Early | Smaller messages | Projectors, queries | Application |
| Projection | | | bound |
| Sampler | Only applicable for scenarios | Sample frequency | immediate |
| | where message loss is acceptable | | |
| | as service degradation | | |
| Message | Endpoint may not be able to | Message size, exception | immediate |
| size-based | resend message in smaller | context including | |
| rejector | size/chunks, thus sender endpoint | recommended actions | |
| | may be forced into an unresolvable | | |
| | error. | | |
| Splitter | Reduces memory consumption in | EIP splitter | Immediate |
| | non-streaming scenarios, endpoints | | |
| | handling messages may perform | | |
| | better processing smaller | | |
| | messages. (For example, assume | | |
| | receiver endpoint is processing | | |
| | XML messages with an DOM | | |
| | parser. It would be a good idea to | | |
| | introduce a stream-based splitter in | | |
| | the integration process to allow | | |
| | endpoints to process large | | |
| | messages more efficiently.) | | |
| Data | Higher throughput | Partitioning conditions, | immediate |
| Partitioner | | partitioning schema | |

Scaling

The scaling countermeasure patterns for message-based integration target adding or reducing resources used by integration content. Tables 2.1 and 2.2 describe scaling countermeasures. Note that Table 2.2 is a continuation of Table 2.1, where Tables 2.1 and 2.2 together form a complete table describing scaling countermeasures. When Tables 2.1 and 2.2 forming into a complete table, the column of consequences in Table 2.2 is adjacent to the column of on which resources in Table 2.1. In other words, each scaling countermeasure is described by columns in order of name, known implementations, covered by current EIPs, effect, on which resources, consequences, configuration, and expected time to effect.

TABLE 2.1
Scaling countermeasures

| | Known | Covered by | | On Which |
|---|---|---|---|---|
| Name | Implementations | current EIPs | Effect | Resources |
| Scaling out | SPARK, FLINK | no | Increasing | Adapters, |
| | | | resources, | operations, |
| | | | increasing costs | endpoints, |
| | | | | for number of |
| | | | | connections |
| Scaling down | None | no | Decreasing | Adapters, |
| | | | resources, | operations, |
| | | | decreasing costs | endpoints, |
| | | | | for number of |
| | | | | connections |
| Load balancer | APACHE | no | Distribute load −> | Messages, services |
| | CAMEL | | resource | |
| | | | consumption and | |
| | | | higher throughput | |
| Parallelization | APACHE | no | Parallel | Messages, |
| | CAMEL | | processing | operations |

TABLE 2.2
Scaling countermeasures (Continued)

| Name | Consequences | Configuration | Expected time to effect |
|---|---|---|---|
| Scaling out | For streaming, stateless | Max computing | Startup time of |
| | integration process | instances | computing instance + |
| | resources should scale | | LB reconfiguration time |
| | linear with computing | | |
| | instance | | |
| Scaling down | Saving resources that can | Re-configure Load | After all messages are |
| | be used by others | Balancer (LB) | processed + shutdown |
| | | | time + LB re- |
| | | | configuration time |
| Load balancer | Higher throughput, more | Load balancing | immediate |
| | balanced system | schema | |
| Parallelization | Higher throughput, requires | Parallelization | Immediate |
| | stateless processes or | property | |
| | operations | | |

The scaling countermeasures can perform:
scale out and back (resource efficiency)
load balancing (leveled), dynamic routing (for example, load balancing on content level)
parallelization, for example, cluster lock
   For instance, load balancing could be added on an integration process level for operation scaling. A load balancer can split load among multiple processors.

Constraints

The content, as well as the consumed services underlie certain constraints. For instance, to be able to use streaming and micro-batching the operations and the integration processing technology have to be able to handle streams and batches of messages. Another example of constraint is whether the integration process can lose data or not. Likewise, the states have an impact on the allowed countermeasures:
In stateless integration processes, messages are always processed as single item without storing context information for following messages. This reduces dependency to storage services and/or reduces main memory consumption. It allows parallelization/scale out without synchronization of state.
In stateful integration processes, message processing can modify state which may be accessed for processing following messages (for example, aggregation). Higher memory/storage consumption, requires additional synchronization effort (or other means) in parallelization/scale out.

Some of these optimizations can be applied on different levels: from single operations, processes up to whole integration scenarios for the content, as well as on VM-level and for external service configurations. The optimizations and their constraints have interdependencies that have to be respected that negatively impact their composition, for example:
micro-batcher conflicts with splitter and streaming with small windows
the streaming conflicts with the micro batcher
there are no conflicts for condition re-ordering
early selection should be executed, before early projection
execute sampler and message rejecter as early as possible
splitter and micro-batcher might conflict, however, could be used as compose message processor in some cases
scale down has no further conflicts
scale out, load balancer and parallelization conflict with stateful components in the process
   The general composition scheme is the following:
scale on lower levels (below VM-level) until resources of this one VM reach their limits; and
apply VM-level optimizations and copy local optimizations, if not conflicting.
   The scale down scheme is as follows:
remove VM-level instances; and
then remove resource consuming optimizations like scale down on content level, reducing threads for parallelization that can now be used for other scenarios.

Examples: Integration Content Scaling

Through the classifiers, the current load situations can be identified and assessed. Now, let us go through the different levels that can be improved, which are defined as scaling patterns. The integration system and its parts require resources that they consume as services: service scaling.

Scalable Adapter

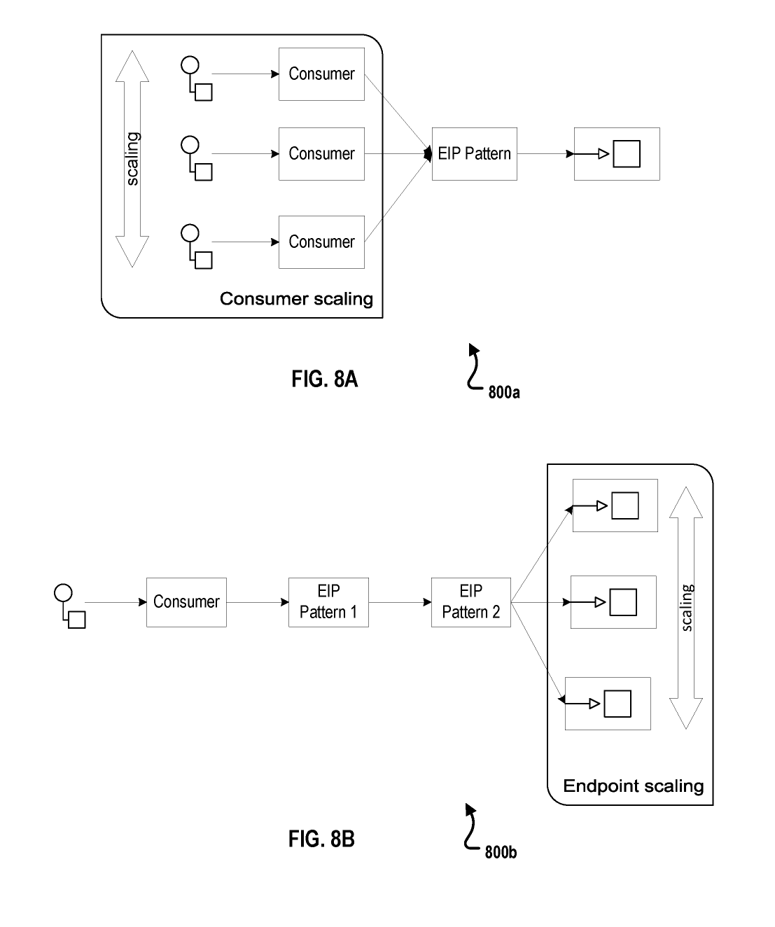

The integration system (intra VM) has adapters that can be scaled (for example, adapter scaling on content level) on the sender and receiver side. FIG. 8A shows a scalable sender adapter 800a, according to an implementation. FIG. 8B shows a scalable receiver adapter 800b, according to an implementation. The scalable sender adapter requires a (parallel) “load balancer” pattern (not shown in FIGS. 8A and 8B) to distribute the messages (that is, no copy) and a “join router” pattern to combine the control flows (that is, no data merge). Similarly, the scalable receiver adapter uses a load balancing scheme. A scalable adapter is a protocol adapter whose instances have no side effects on the pair-wise processing. Thereby, distributed state should be avoided, since the synchronization costs might eat up the parallelization benefit. For instance, the user datagram protocol (UDP) adapter denotes a scalable adapter.

Re-Order Message Processor

The message processors or operations can be re-ordered, for example, for better performance. The re-ordering possibilities are limited by the dependencies, states (that is, stateless processors can be re-arranged better) and control flow constraints (for example, first decrypt message then map).

Scalable Message Processor

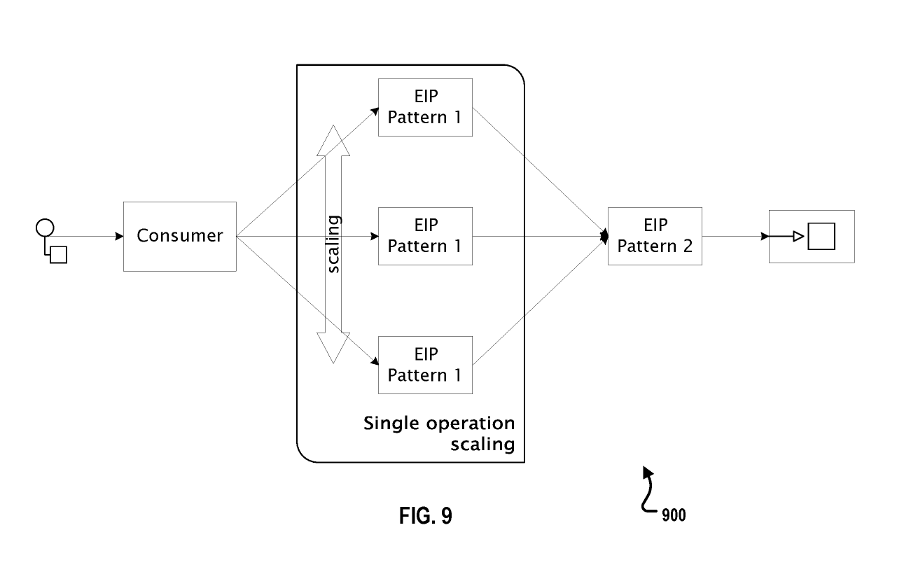

The message processors can also be scaled on an instance level. This again uses a load balancing and join routing. For instance, it can be used for “bottleneck” operations. FIG. 9 shows a scalable message processor 900, according to an implementation.

Scalable Sub-Process

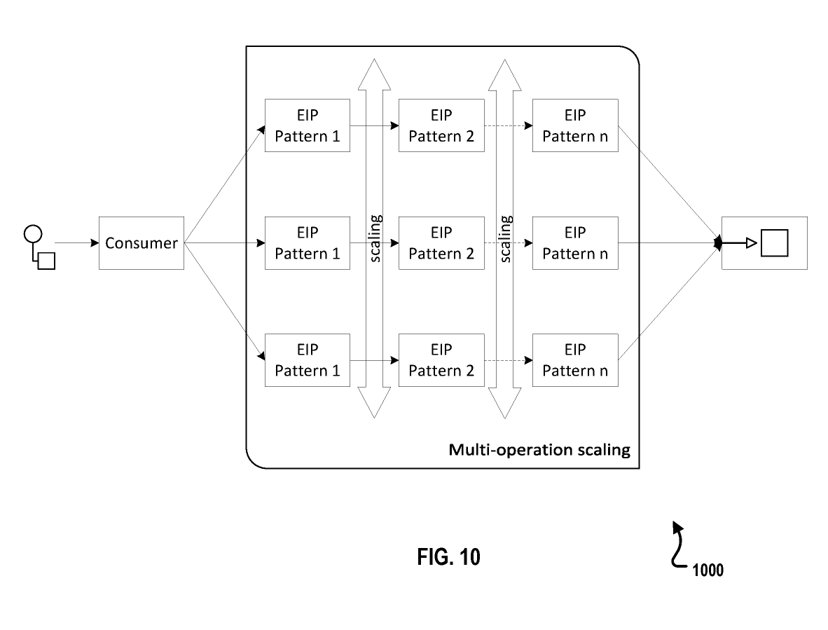

Sub-processes are an ordered set of message processors. Scaling of sub-processes can be performed for the cases with or without adapters. FIG. 10 shows a scalable sub-process 1000, according to an implementation.

Scalable Integration Process

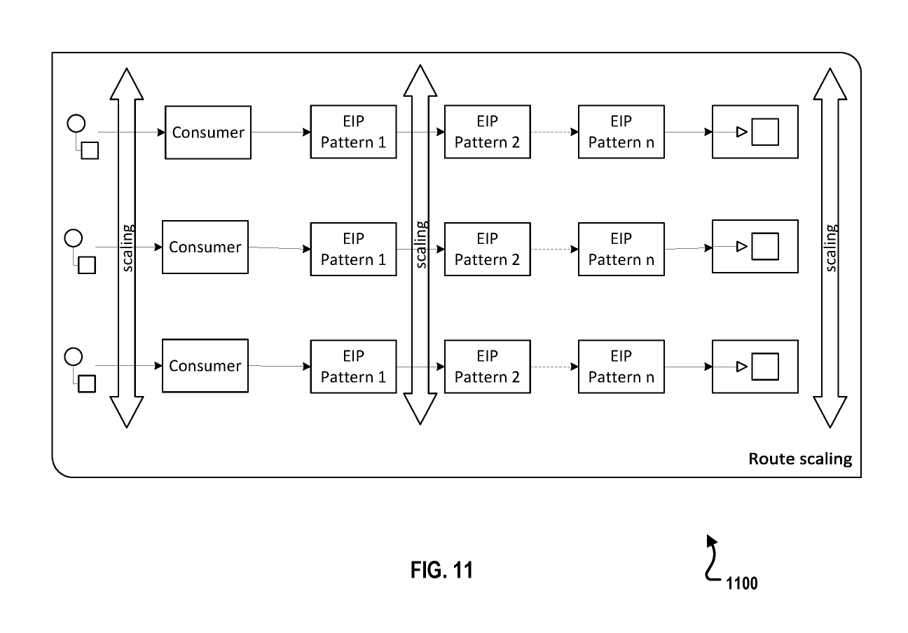

Scaling the whole integration process can be done by copying it to several processing nodes. This could leverage VM-scaling, for example, multiple VMs with content. FIG. 11 shows a scalable integration process 1100, according to an implementation.

Countermeasures Applied

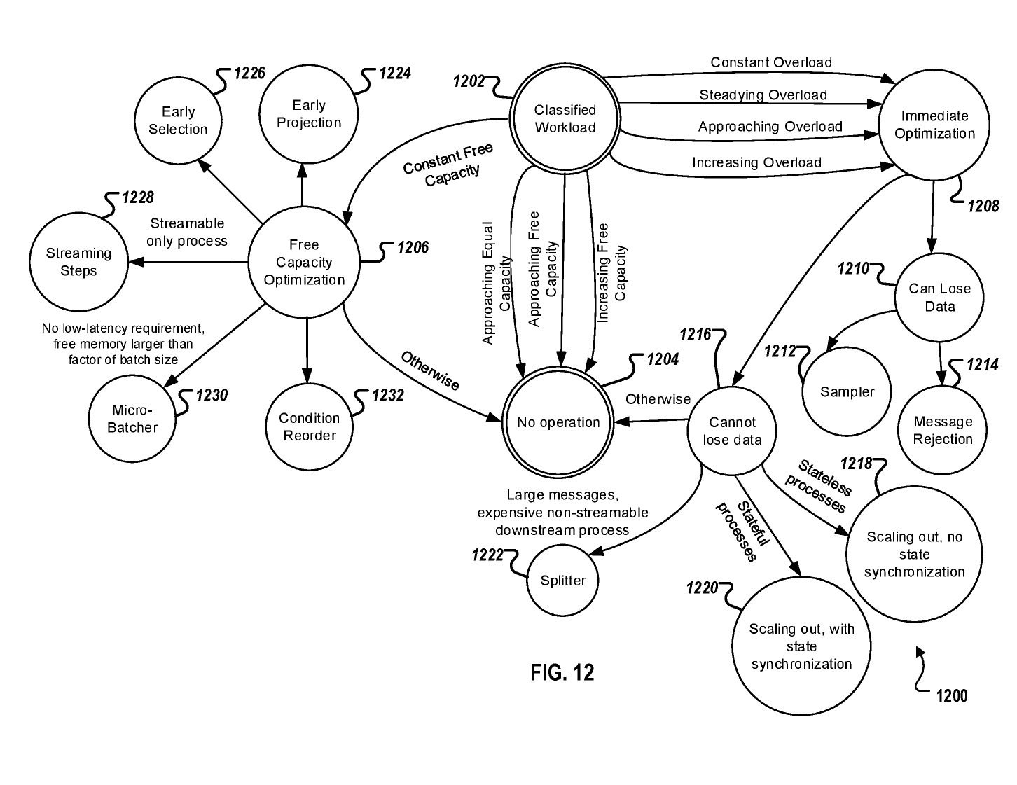

The countermeasures discussed above can be brought into context with the categorized load situations. FIG. 12 shows a decision tree 1200 to illustrate applicable operations, according to an implementation. FIG. 12 reads as follows:
The double lined nodes 1202 and 1204 can be seen similar to start or end states. The input into the start state is the classified workload 1202. One end state is no operation 1204.
The evaluation of the classified workload is called iteratively and re-evaluated.
The edges denote the classified workloads that lead to nodes that represent the operations executed based on the urgency of the countermeasure: no operation 1204 (“nothing to be done”), free capacity optimization 1206 (“perform actions”), immediate optimization 1208 (“urgent tasks”).
Along the directed edges including their constraints, possible optimizations are selected.
If none of the constraints applies, no operation 1204 is executed.
During the next re-evaluation, changed situations might require other optimizations.
Note: free capacity optimization can lead to an undo of a previous immediate optimization, for example, if the previous optimization was a scale operation and the current optimization improves the workload toward less messages to be processed like using an early select.

As shown in FIG. 12, if the classified workload 1202 is constant overload, steadying overload, approaching overload, or increasing overload, immediate optimization 1208 is performed. If the system can lose data 1210, the countermeasure can be a message rejecter 1214 or a message sampler 1212 as described in Tables 1.1 and 1.2. If the system cannot lose data 1216, depending on system constraints, the countermeasure can be a message splitter 1222 as described in Tables 1.1 and 1.2, scaling out as described in Tables 2.1 and 2.2 and FIGS. 8-11, or no operation 1204. The scaling out can be scaling out without state synchronization 1218 or scaling out with state synchronization 1220 depending on whether the processes are stateful or stateless. If the classified workload 1202 is constant free capacity, free capacity optimization 1206 is performed. Depending on system constraints, the countermeasure can be early projection 1224, early selection 1226, steaming 1228, micro-batcher 1230, or condition reorder 1232 as described in Tables 1.1 and 1.2. For example, steaming 1228 can be applied if the system can handle streaming. Similarly, micro-batcher 1230 can be applied if the system supports micro-batching.

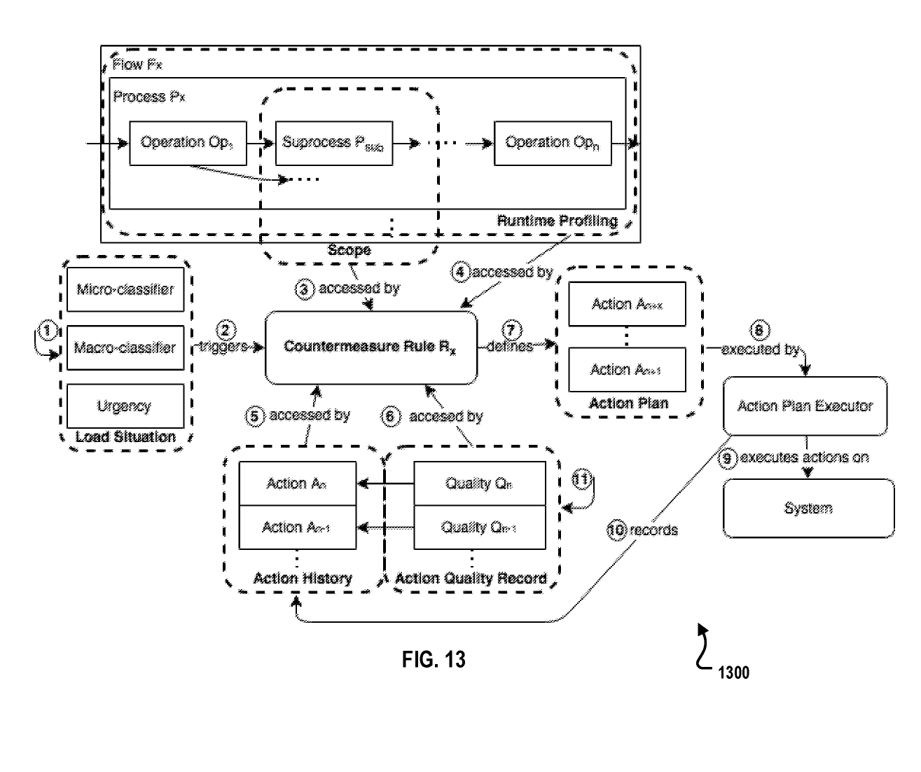

Based on the decision tree in FIG. 12, FIG. 13 shows a general state machine with memory that illustrates behavioral aspects of integration scenario domain-specific and leveled resource elasticity and management, according to an implementation. The description of the behavior is done rule-based. The rule uses (1) the classified workload (that is, micro, macro, and urgency), (3) the scope (that is, integration flow, integration process, and integration operation), (5) the action history and (6) recorded quality of actions per identified situation. In addition, (4) the runtime profiling is used for instance for branch predictions. The countermeasure rules are triggered by (2) the actual load situation event. The output (7) is the countermeasure and translates to an action plan that (8) is executed on the runtime and (9) system configurations. During the execution, (10) runtime records are captured together with (11) the action's quality record. Both are accessed by countermeasure rules in future iterations, as described.

The rules look like the tuple: observable/state and action/countermeasure. For instance, the following example denotes a rule that translates to a scale out action plan in three iterations until the situation is under control:

Iteration 1:
Observable/state (with history and quality)
   micro-classifier predicts increasing load
   macro-classifier predicts non-periodic behavior
   urgency is high
   the scenario is stateless and cannot lose data
   state: approaching overload
   action history is empty (that is, no previous actions applied)
   quality records are empty
   currently available resources (from resource micro-classifier) shows sufficient resources for up to two scale outs (that is, scaling out on the integration process level)
Action/countermeasure on which level
   scale out by adding one more instance on the integration process level (that is, during the next iteration, another scale out might take place), therefore two instances on the integration process level
   deploy load balancing configuration (for example, equally distributed load)

Iteration 2:
Observable/state (with history and quality)
   micro-classifier predicts increasing load
   macro-classifier predicts non-periodic behavior
   urgency is high
   the scenario is stateless and cannot lose data
   state: increasing overload
   action history shows scale out
   quality records show scale out as high efficient in this situation, therefore one more instance scale out was not enough
   currently available resources (from resource micro-classifier) shows sufficient resources for up to two scale outs.
Action/countermeasure on which level
   scale out by adding one more instance on the integration process level (that is, during the next iteration, another scale out might take place), therefore three instances on the integration process level
   adjust load balancing configuration (for example, equally distributed load)

Iteration 3:
Observable/state (with history and quality)
   micro-classifier shows steady load
   macro-classifier predicts non-periodic behavior
   urgency is low
   the scenario is stateless and cannot lose data
   state: constant free capacity
   action history shows two scale outs on the integration process level (no more possible scale out on the integration process level, therefore next time scale out on VM level is necessary); Advice: no operation.
   quality records: not applicable
   currently available resources (from resource micro-classifier) shows insufficient resources for scale outs.
   action/countermeasure on which level
      No operation, and three instances on the integration process level
         In iteration 3, optional optimizations could be performed.

In a typical implementation, a load pattern is first observed. An action is determined and applied based on the observed load pattern. After applying the action, the system continues to monitor the load pattern and takes appropriate actions to avoid overload.

Multi-Level Resource Management and Elasticity Model

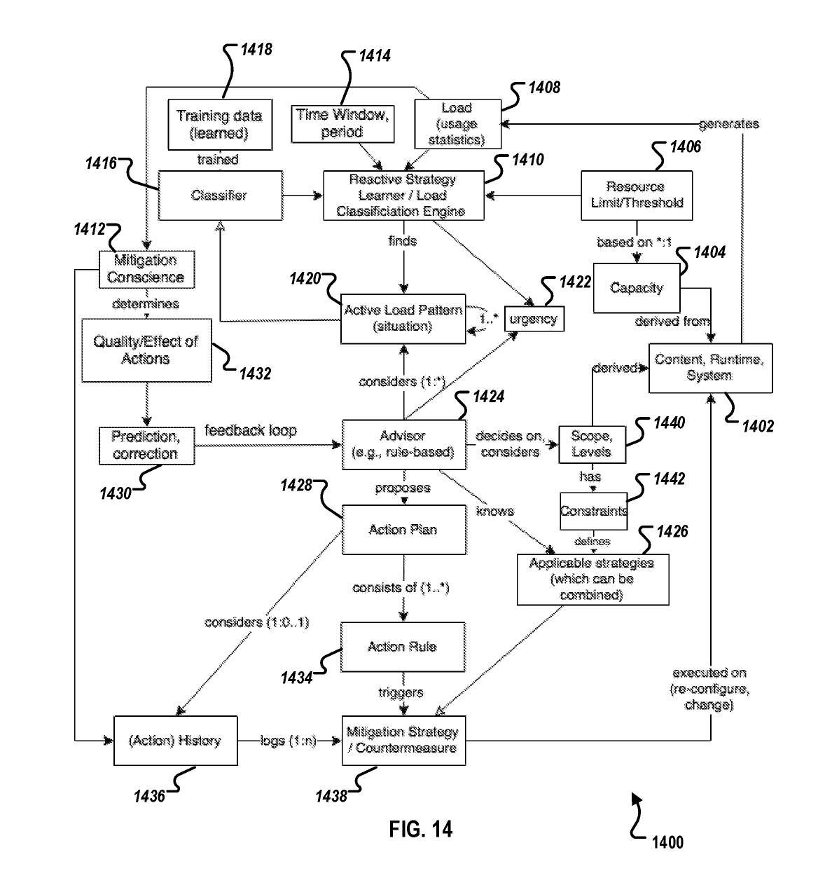

One of the general countermeasure variants in case of critical messaging and resource situations is elasticity. While this has been analyzed on a VM-level already by existing approaches, the described approach focuses on the outlined issues within the integration domain (including systems and capacities). FIG. 14 is a diagram 1400 illustrating integration scenario domain-specific and leveled resource elasticity and management, according to an implementation. FIG. 14 includes the following:
The integration content in form of integration processes is deployed to the runtime system stack 1402.
The runtime stack 1402 runs on hardware or a VM and (a) derives all capacity limitations 1404 from it (for example, resource limits and thresholds 1406) and (b) has limits due to its design and in particular derived from the integration domain (as discussed in integration domain capacities; for example, message throughput, service capacities).
During runtime of the integration content, load/usage statistics 1408 are generated and communicated for analysis. These statistics combine all relevant information for making the resource limits tractable (as discussed in definition of load patterns section).
In the described approach, these statistics go to at least these two smart processors:
   the load classification engine 1410, which classifies the load situations based on the load/usage statistics 1408 and a reactive strategy learner (that is, reactive)
   the mitigation conscience 1412, which assesses the quality of the load classification engine 1410 (that is, predictive)
In addition to the load/usage statistics 1408, the load classification engine 1410 requires the following information:
   A time window period 1414 that allows for the identification of load patterns based on temporal aspects (for example, every first Monday of the month)
   A set of classifiers 1416 (as discussed in classifier definition section) that were trained using training data sets 1418 (for example, using a machine learning approach)
The classifiers 1416 let the load classification engine 1410 find active load pattern situations 1420 that are probable. The active load pattern situations 1420 are ranked by the load classification engine 1410 due to their probabilities.
These probabilities are influenced by the history of the time series of all the metrics (denoted by usage statistics 1408).
Based on the classification result, a situation is identified and its urgency 1422 is rated. The urgency 1422 limits the selection of possible countermeasure patterns that are indirectly proposed by the advisor 1424.
The advisor 1424 considers the load situations, their probabilities and urgencies.
Since changes can be made on different levels or scopes 1440, which constrain 1442 the applicable strategies 1426 (potentially combined) based on the architecture of the integration runtime system 1402, the advisor 1424 has levels of freedom for selecting a good action plan 1428.
For that the advisor 1424 consumes predictions and corrections 1430 from the mitigation conscience 1412, which rates the quality of past action plans and actions 1432 (that is, mitigation strategies).
Thereby an action plan 1428 consists of several action rules 1434 that represent and trigger different mitigation strategies/countermeasures.
   The action plans 1428 consider the action history 1436, in which also the mitigation strategies 1438 are logged.
   The action history 1436 is considered by the mitigation conscience 1412.
The triggered mitigation strategies 1438 influence the runtime system 1402 by re-configuring/changing the runtime content or resources.
The changed content and configurations are executed on the runtime system 1402.

System Design

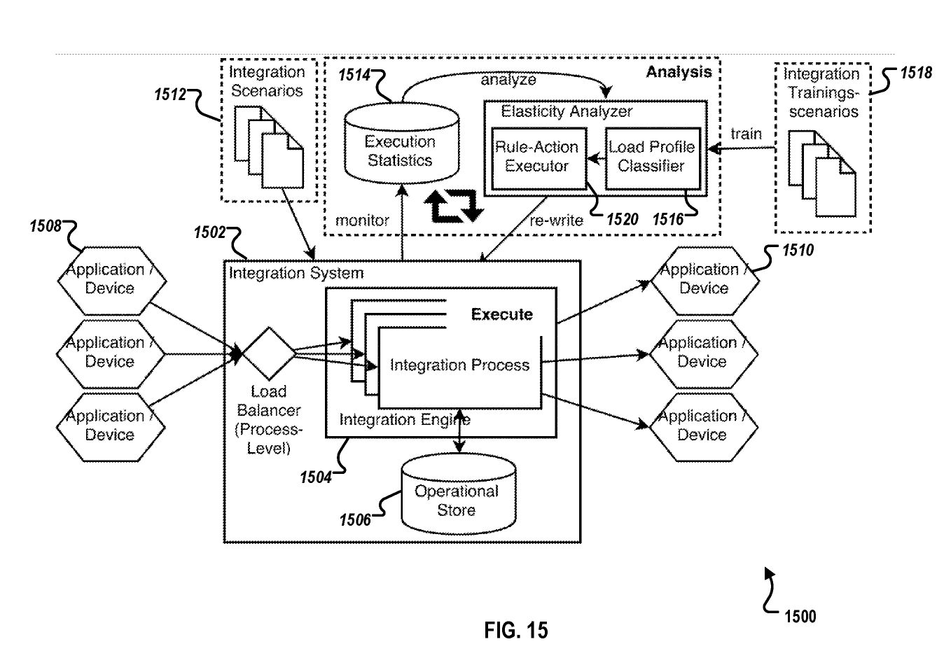

To illustrate the feasibility of this design, FIG. 15 demonstrates a system 1500 that executes design aspects of integration scenario domain-specific and leveled resource elasticity and management, according to an implementation.

General Setup

The system comprises an integration system 1502 with an integration engine 1504 (that is, the runtime) and an operational store 1506. The system already has load-balancing capabilities on different levels. FIG. 15 shows only the process level load balancer. Applications and devices (that is, transmitting applications and devices 1508) send data to receivers (that is, receiving applications and devices 1510) via the integration system 1502. Therefore, integration scenarios 1512 are deployed on the integration system 1502. A monitor collects execution semantics/statistics 1514 that are analyzed using a machine learning approach (depicted as load profile classifier 1516). The machine learning is trained by specially created case data sets for the defined load situation classifiers (such as the integration training scenarios 1518). The machine learning (ML) component hands the information to the countermeasure rule in the rule-action executor 1520. From there, the hypervisor APIs (not shown in FIG. 15) are used to execute the action plans. The inner workings of the latter two concepts will be discussed below.

Multi-Level Machine Learning

An ML approach is used to determine two things during the execution of the system:
micro and macro-classifiers that are learned using a neuronal network from classifier training data
game plan (not shown in FIG. 15): A corrective measure (denoted by the quality reports) learned from the action history and the result/success for future iterations learned from historic actions, current load situation, and the deviation in terms of: helped to improve the situation or not. Thereby, the trade-off between action history and current situation can be seen as classifier of different countermeasures

For the micro classifier, learning an example neuronal network with five output states (according to the cases discussed above) is implemented. Table 3 shows the performance of the neuronal network including the number of training data, the number of misjudged load situations as error and the error ratio. Fifteen input data points are sufficient for this case because the performance does not improve when the input data points are increased to 700. As shown in Table 3, most of the cases can be recognized correctly. Only for the constant load case (that is, case 1) the noise on the data (no straight line, but small ups and downs) leaves the network uncertain about the current situation. Hence the neuronal network gets all cases with a similar value. When recognizing this situation as the constant case, the error ratio of this case is close to zero errors.

TABLE 3
Neuronal network performance for micro classifier learning

| | Number of | Number of | |
|---|---|---|---|
| Case | training data | errors | Error rate |
| 1 | 46 | 46 | 100% |
| 2a | 86 | 1 | 1.16% |
| 2b | 54 | 6 | 11.11% |
| 3a | 80 | 0 | 0% |
| 3b | 53 | 14 | 26.42% |
| Total | 319 | 67 | 21% |
| Total without Case 1 | 273 | 21 | 7.69% |

The sample implementation includes the following aspects:
focusing on the message throughput capacity metric;
implementing the classifiers from the concept as (output) neurons in a neuronal network. The network is an Artificial Neuronal Network (ANN) created by a NeuroEvolution of Augmenting Topologies (NEAT) algorithm that can generate biased neurons;
training the classifiers with several hundred input data sets (including noise) that characterize the classifiers;
the training helps to learn the classifiers and calculates the error.

Hypervisor Extensions

For the execution of the actions, the describe approach extends the hypervisor to execute actions based on the action plans it gets from the system. It does not contain any additional logic about the decisions made, however, uses its existing primitives like create VM and additional ones like scale IS operation or scale sub-process according to the action plan.

Guiding Example

Following is a guiding example including:
One sender
Runtime, System:=IFlow, where the integration flow has one sender and capacity is determined by benchmark as well as other properties such as stateful involving database
   IFlow:=capacity limit ˜3,000 messages/second, stateful (experimentally determined from benchmark or learning)
   Services:=database, where the database services might have limits themselves
The flow consists of operators/elements with their capacities: operations={ cbr˜10,000, selectivity; aggregator˜1,000}, adapters :={ http˜5,000}
Constraint:=number of connections=1 allowed (hence no adapter scaling is allowed because the adapter is limited to one connection)
Reactive Strategy Learner—Classifier:=increase over limit (the load situation detected by the classifier) {urgency: soon ˜2,500 or immediate current load 3,000}, therefore actual possible load:=5,000 messages/second (unknown)
Resources DB:=7 connections (the amount of database resources); transactions per second per one connection=5,000
History={ } (empty history indicating the beginning of the process)
Possible scopes for countermeasures:
   Adapters not possible due to constraint
   Everything else possible
Estimate throughput
   Max from CBR=10,000
   Aggregator only 7 threads due to connections
   Overall max=5,000
   Decision (urgency=immediate): scale aggregator to 5 threads. The single operation scaling for “bottleneck” operation can be done immediately.
   Decision (urgency=soon): IS to sender to throttle 3,000 (note that for two senders, conversation with the sender is used to ask to apply countermeasure), or sample (because the sender knows about the semantics of the data). In other words, to avoid further overload, the sender is asked to reduce an amount of uncritical data.
Apply action plan
After action is applied, check quality of decision by monitoring load
   Urgency soon: monitor and rate behavior of sender, such as penalties or trust
   Urgency immediate: monitor effect, for example compare with 5,000 messages/second
   Monitor resources
   DB connections now 5: could be critical
   whether there are more messages critical for memory or CPU

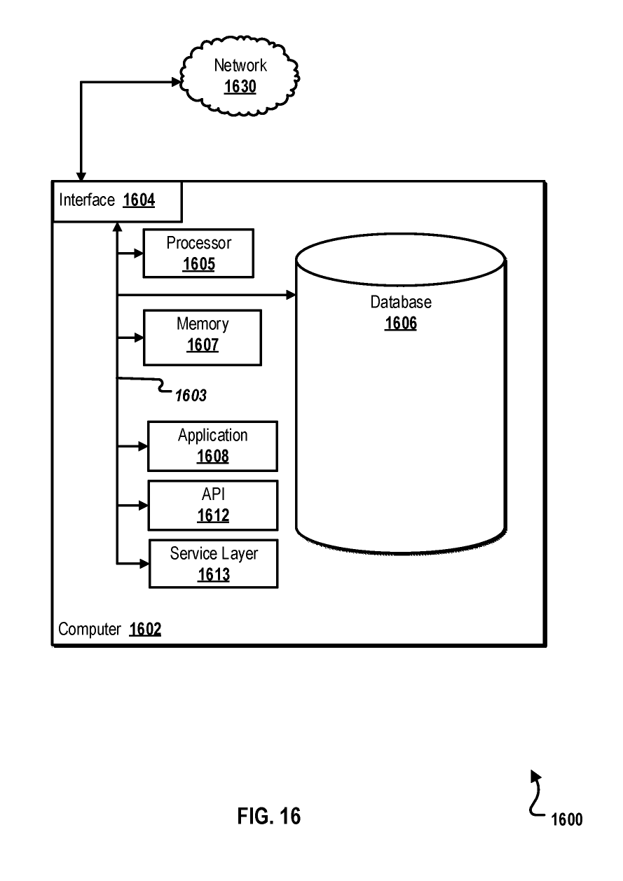

FIG. 16 is a block diagram of an exemplary computer system 1600 used to provide computational functionalities associated with described algorithms, methods, functions, processes, flows, and procedures as described in the instant disclosure, according to an implementation. The illustrated computer 1602 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 1602 may comprise a computer that includes an input device, such as a keypad, keyboard, touch screen, or other device that can accept user information, and an output device that conveys information associated with the operation of the computer 1602, including digital data, visual, or audio information (or a combination of information), or a graphical user interface (GUI).

The computer 1602 can serve in a role as a client, network component, a server, a database or other persistency, or any other component (or a combination of roles) of a computer system for performing the subject matter described in the instant disclosure. The illustrated computer 1602 is communicably coupled with a network 1630. In some implementations, one or more components of the computer 1602 may be configured to operate within environments, including cloud-computing-based, local, global, or other environment (or a combination of environments).

At a high level, the computer 1602 is an electronic computing device operable to receive, transmit, process, store, or manage data and information associated with the described subject matter. According to some implementations, the computer 1602 may also include or be communicably coupled with an application server, e-mail server, web server, caching server, streaming data server, or other server (or a combination of servers).

The computer 1602 can receive requests over network 1630 from a client application (for example, executing on another computer 1602) and responding to the received requests by processing the said requests in an appropriate software application. In addition, requests may also be sent to the computer 1602 from internal users (for example, from a command console or by other appropriate access method), external or third-parties, other automated applications, as well as any other appropriate entities, individuals, systems, or computers.

Each of the components of the computer 1602 can communicate using a system bus 1603. In some implementations, any or all of the components of the computer 1602, both hardware or software (or a combination of hardware and software), may interface with each other or the interface 1604 (or a combination of both) over the system bus 1603 using an application programming interface (API) 1612 or a service layer 1613 (or a combination of the API 1612 and service layer 1613). The API 1612 may include specifications for routines, data structures, and object classes. The API 1612 may be either computer-language independent or dependent and refer to a complete interface, a single function, or even a set of APIs. The service layer 1613 provides software services to the computer 1602 or other components (whether or not illustrated) that are communicably coupled to the computer 1602. The functionality of the computer 1602 may be accessible for all service consumers using this service layer. Software services, such as those provided by the service layer 1613, provide reusable, defined functionalities through a defined interface. For example, the interface may be software written in JAVA, C++, or other suitable language providing data in extensible markup language (XML) format or other suitable format. While illustrated as an integrated component of the computer 1602, alternative implementations may illustrate the API 1612 or the service layer 1613 as stand-alone components in relation to other components of the computer 1602 or other components (whether or not illustrated) that are communicably coupled to the computer 1602. Moreover, any or all parts of the API 1612 or the service layer 1613 may be implemented as child or sub-modules of another software module, enterprise application, or hardware module without departing from the scope of this disclosure.

The computer 1602 includes an interface 1604. Although illustrated as a single interface 1604 in FIG. 16, two or more interfaces 1604 may be used according to particular needs, desires, or particular implementations of the computer 1602. The interface 1604 is used by the computer 1602 for communicating with other systems in a distributed environment that are connected to the network 1630 (whether illustrated or not). Generally, the interface 1604 comprises logic encoded in software or hardware (or a combination of software and hardware) and operable to communicate with the network 1630. More specifically, the interface 1604 may comprise software supporting one or more communication protocols associated with communications such that the network 1630 or interface's hardware is operable to communicate physical signals within and outside of the illustrated computer 1602.

The computer 1602 includes a processor 1605. Although illustrated as a single processor 1605 in FIG. 16, two or more processors may be used according to particular needs, desires, or particular implementations of the computer 1602. Generally, the processor 1605 executes instructions and manipulates data to perform the operations of the computer 1602 and any algorithms, methods, functions, processes, flows, and procedures as described in the instant disclosure.

The computer 1602 also includes a database 1606 that can hold data for the computer 1602 or other components (or a combination of both) that can be connected to the network 1630 (whether illustrated or not). For example, database 1606 can be an in-memory, conventional, or other type of database storing data consistent with this disclosure. In some implementations, database 1606 can be a combination of two or more different database types (for example, a hybrid in-memory and conventional database) according to particular needs, desires, or particular implementations of the computer 1602 and the described functionality. Although illustrated as a single database 1606 in FIG. 16, two or more databases (of the same or combination of types) can be used according to particular needs, desires, or particular implementations of the computer 1602 and the described functionality. While database 1606 is illustrated as an integral component of the computer 1602, in alternative implementations, database 1606 can be external to the computer 1602.

The computer 1602 also includes a memory 1607 that can hold data for the computer 1602 or other components (or a combination of both) that can be connected to the network 1630 (whether illustrated or not). For example, memory 1607 can be random access memory (RAM), read-only memory (ROM), optical, magnetic, and the like storing data consistent with this disclosure. In some implementations, memory 1607 can be a combination of two or more different types of memory (for example, a combination of RAM and magnetic storage) according to particular needs, desires, or particular implementations of the computer 1602 and the described functionality. Although illustrated as a single memory 1607 in FIG. 16, two or more memories 1607 (of the same or combination of types) can be used according to particular needs, desires, or particular implementations of the computer 1602 and the described functionality. While memory 1607 is illustrated as an integral component of the computer 1602, in alternative implementations, memory 1607 can be external to the computer 1602.

The application 1608 is an algorithmic software engine providing functionality according to particular needs, desires, or particular implementations of the computer 1602, particularly with respect to functionality described in this disclosure. For example, application 1608 can serve as one or more components, modules, applications, etc. Further, although illustrated as a single application 1608, the application 1608 may be implemented as multiple applications 1607 on the computer 1602. In addition, although illustrated as integral to the computer 1602, in alternative implementations, the application 1608 can be external to the computer 1602.

There may be any number of computers 1602 associated with, or external to, a computer system containing computer 1602, each computer 1602 communicating over network 1630. Further, the term “client,” “user,” and other appropriate terminology may be used interchangeably as appropriate without departing from the scope of this disclosure. Moreover, this disclosure contemplates that many users may use one computer 1602, or that one user may use multiple computers 1602.

Described implementations of the subject matter can include one or more features, alone or in combination.

For example, in a first implementation, a computer-implemented method comprising: determining system-level resource capacities and application-level resource capacities associated with an integration system in a distributed computing environment, the integration system including an integration process; identifying a workload associated with the integration system based on the determined system-level capacities and application-level capacities; identifying at least one constraint associated with the integration system; and determining a countermeasure for resource elasticity and management based on the identified workload and constraint.

The foregoing and other described implementations can each optionally include one or more of the following features:

A first feature, combinable with any of the following features, wherein the system-level resource capacities include at least one of a resource capacity of CPU, memory, disk input/output, or network bandwidth.

A second feature, combinable with any of the previous or following features, wherein the application-level capacities include at least one of a limit of throughput, message size, number of messages, number of connections.

A third feature, combinable with any of the previous or following features, identifying the workload includes identifying at least one of a micro-load pattern, a macro-load pattern, or an urgency of performing resource optimization.

A fourth feature, combinable with any of the previous or following features, wherein the identified workload includes at least one of constant overload, steadying overload, approaching overload, increasing overload, constant free capacity, approaching equal capacity, approaching free capacity, or increasing free capacity.

A fifth feature, combinable with any of the previous or following features, wherein the constraint includes at least one of whether the integration process is stateless or stateful, whether the integration process can lose data, whether the integration process can handle streaming, or whether the integration process can handle micro-batching.

A sixth feature, combinable with any of the previous or following features, wherein when the identified workload is constant free capacity, the countermeasure includes at least one of early projection, early selection, steaming, or micro-batching.

A seventh feature, combinable with any of the previous or following features, wherein when the identified workload is one of constant overload, steadying overload, approaching overload, or increasing overload and the constraint is that the integration process can lose data, the countermeasure includes at least one of a message rejecter or a message sampler.

An eighth feature, combinable with any of the previous or following features, wherein when the identified workload is one of constant overload, steadying overload, approaching overload, or increasing overload and the constraint is that the integration process cannot lose data, the countermeasure includes at least one of a message splitter or scaling out.

A ninth feature, combinable with any of the previous or following features, wherein the scaling out includes at least one of scaling an adaptor, scaling a message processor, scaling a sub-process, scaling an integration process, or scaling an integration flow.

A tenth feature, combinable with any of the previous or following features, the method further comprising: evaluating effectiveness of the countermeasure; and storing information of the effectiveness of the countermeasure.

An eleventh feature, combinable with any of the previous or following features, the method further comprising identifying an action plan based on the countermeasure and historical effectiveness of the countermeasure.

In a second implementation, a non-transitory, computer-readable medium storing one or more instructions executable by a computer system to perform operations comprising: determining system-level resource capacities and application-level resource capacities associated with an integration system in a distributed computing environment, the integration system including an integration process; identifying a workload associated with the integration system based on the determined system-level capacities and application-level capacities; identifying at least one constraint associated with the integration system; and determining a countermeasure for resource elasticity and management based on the identified workload and constraint.

The foregoing and other described implementations can each optionally include one or more of the following features:

A first feature, combinable with any of the following features, wherein the system-level resource capacities include at least one of a resource capacity of CPU, memory, disk input/output, or network bandwidth.

A second feature, combinable with any of the previous or following features, wherein the application-level capacities include at least one of a limit of throughput, message size, number of messages, number of connections.

A third feature, combinable with any of the previous or following features, wherein the identified workload includes at least one of constant overload, steadying overload, approaching overload, increasing overload, constant free capacity, approaching equal capacity, approaching free capacity, or increasing free capacity.

A fourth feature, combinable with any of the previous or following features, wherein the constraint includes at least one of whether the integration process is stateless or stateful, whether the integration process can lose data, whether the integration process can handle streaming, or whether the integration process can handle micro-batching.

A fifth feature, combinable with any of the previous or following features, comprising one or more instructions to: evaluate effectiveness of the countermeasure; and store information of the effectiveness of the countermeasure.

A sixth feature, combinable with any of the previous or following features, comprising one or more instructions to identify an action plan based on the countermeasure and historical effectiveness of the countermeasure.

In a third implementation, a computer-implemented system comprising a computer memory and a hardware processor interoperably coupled with the computer memory and configured to perform operations comprising: determining system-level resource capacities and application-level resource capacities associated with an integration system in a distributed computing environment, the integration system including an integration process; identifying a workload associated with the integration system based on the determined system-level capacities and application-level capacities; identifying at least one constraint associated with the integration system; and determining a countermeasure for resource elasticity and management based on the identified workload and constraint.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively, or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., less than 5 secs., etc. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate. Thresholds used to make computational determinations can be statically, dynamically, or both statically and dynamically determined.

The methods, processes, logic flows, etc. described in this specification can be performed by one or more programmable computers executing one or more computer programs to perform functions by operating on input data and generating output. The methods, processes, logic flows, etc. can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM), or both. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described above should not be understood as requiring such separation or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

Furthermore, any claimed implementation below is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
determining system-level resource capacities and application-level resource capacities associated with an integration system in a distributed computing environment, the integration system including an integration process;
identifying a workload associated with the integration system based on the determined system-level capacities and application-level capacities;
identifying at least one constraint associated with the integration system; and
determining a countermeasure for resource elasticity and management based on the identified workload and constraint.

2. The computer-implemented method of claim 1, wherein the system-level resource capacities include at least one of a resource capacity of CPU, memory, disk input/output (I/O), or network bandwidth.

3. The computer-implemented method of claim 1, wherein the application-level capacities include at least one of a limit of throughput, message size, number of messages, number of connections.

4. The computer-implemented method of claim 1, wherein identifying the workload includes identifying at least one of a micro-load pattern, a macro-load pattern, or an urgency of performing resource optimization.

5. The computer-implemented method of claim 1, wherein the identified workload includes at least one of constant overload, steadying overload, approaching overload, increasing overload, constant free capacity, approaching equal capacity, approaching free capacity, or increasing free capacity.

6. The computer-implemented method of claim 1, wherein the constraint includes at least one of whether the integration process is stateless or stateful, whether the integration process can lose data, whether the integration process can handle streaming, or whether the integration process can handle micro-batching.

7. The computer-implemented method of claim 5, wherein when the identified workload is constant free capacity, the countermeasure includes at least one of early projection, early selection, steaming, or micro-batching.

8. The computer-implemented method of claim 6, wherein when the identified workload is one of constant overload, steadying overload, approaching overload, or increasing overload and the constraint is that the integration process can lose data, the countermeasure includes at least one of a message rejecter or a message sampler.

9. The computer-implemented method of claim 6, wherein when the identified workload is one of constant overload, steadying overload, approaching overload, or increasing overload and the constraint is that the integration process cannot lose data, the countermeasure includes at least one of a message splitter or scaling out.

10. The computer-implemented method of claim 9, wherein the scaling out includes at least one of scaling an adaptor, scaling a message processor, scaling a sub-process, scaling an integration process, or scaling an integration flow.

11. The computer-implemented method of claim 1, further comprising:
evaluating effectiveness of the countermeasure; and
storing information of the effectiveness of the countermeasure.

12. The computer-implemented method of claim 11, further comprising identifying an action plan based on the countermeasure and historical effectiveness of the countermeasure.

13. A non-transitory, computer-readable medium storing one or more instructions executable by a computer system to perform operations comprising:
determining system-level resource capacities and application-level resource capacities associated with an integration system in a distributed computing environment, the integration system including an integration process;
identifying a workload associated with the integration system based on the determined system-level capacities and application-level capacities;
identifying at least one constraint associated with the integration system; and
determining a countermeasure for resource elasticity and management based on the identified workload and constraint.

14. The non-transitory, computer-readable medium of claim 13, wherein the system-level resource capacities include at least one of a resource capacity of CPU, memory, disk input/output (I/O), or network bandwidth.

15. The non-transitory, computer-readable medium of claim 13, wherein the application-level capacities include at least one of a limit of throughput, message size, number of messages, number of connections.

16. The non-transitory, computer-readable medium of claim 13, wherein the identified workload includes at least one of constant overload, steadying overload, approaching overload, increasing overload, constant free capacity, approaching equal capacity, approaching free capacity, or increasing free capacity.

17. The non-transitory, computer-readable medium of claim 13, wherein the constraint includes at least one of whether the integration process is stateless or stateful, whether the integration process can lose data, whether the integration process can handle streaming, or whether the integration process can handle micro-batching.

18. The non-transitory, computer-readable medium of claim 13, comprising one or more instructions to:
evaluate effectiveness of the countermeasure; and
store information of the effectiveness of the countermeasure.

19. The non-transitory, computer-readable medium of claim 18, comprising one or more instructions to identify an action plan based on the countermeasure and historical effectiveness of the countermeasure.

20. A computer-implemented system, comprising:
a computer memory; and
a hardware processor interoperably coupled with the computer memory and configured to perform operations comprising:
determining system-level resource capacities and application-level resource capacities associated with an integration system in a distributed computing environment, the integration system including an integration process;
identifying a workload associated with the integration system based on the determined system-level capacities and application-level capacities;
identifying at least one constraint associated with the integration system; and
determining a countermeasure for resource elasticity and management based on the identified workload and constraint.
